(19) United States
(12) Patent Application Publication
(10) Pub. No.: US 2015/0099382 A1
(43) Pub. Date: Apr. 9, 2015

(54) MULTIPLE-IN-ONE INTERFACE CONNECTOR

(71) Applicant: KUANG YING COMPUTER EQUIPMENT CO., LTD., New Taipei City (TW)

(72) Inventors: CHUN-TE CHANG, New Taipei City (TW); HSUAN-HO CHUNG, New Taipei City (TW); YU-HUNG LIN, New Taipei City (TW); YI-HUNG YU, New Taipei City (TW)

(73) Assignee: KUANG YING COMPUTER EQUIPMENT CO., LTD., New Taipei City (TW)

(21) Appl. No.: 14/047,033

(22) Filed: Oct. 7, 2013

(51) Int. Cl. H01R 27/02; H01R 13/633; H01R 13/6581

(52) U.S. Cl. CPC H01R 27/02; H01R 13/6581; H01R 13/633
USPC 439/152; 439/660; 439/607.23

(57) ABSTRACT

A multiple-in-one interface connector includes a shielding casing, an insulation body received in the shielding casing, a micro card receiving zone formed on a surface of the insulation body and a micro USB connection zone, a card ejection bar movably arranged at one side of the insulation body, and a card ejector rotatably mounted to the insulation body and operatively coupled to the card ejection bar. The insulation body includes a micro card receiving port and a micro USB connection port respectively in the micro card receiving zone and the micro USB connection zone. A micro card and a micro USB male connector can be respectively inserted to the micro card receiving zone and the micro USB connection port. To eject the micro card, the card ejection bar is pushed to move the card ejector so as to eject the micro card out of the micro card receiving zone.

### (A) TECHNICAL FIELD OF THE INVENTION

The present invention provides a structure/specification in which a micro-size specification and a micro USB specification co-exist in a connector, and more particularly a multiple-in-one interface connector in which a micro-size and a micro USB connectors co-exist.

### (B) DESCRIPTION OF THE PRIOR ART

Universal Serial Bus (USB) connectors have various advantages, including plug-and-play and high-speed transmission. The transmission capacity of the USB standard has been greatly improved, from the first-developed USB1.0 specification to the currently available micro USB3.0, and has been commonly used in electronic products. The USB-related transmission protocols are specifications set up by USB Implementer Forum Inc. (USB-IF) and all the USB connectors must comply with the specifications in order to communicate with other USB connectors.

The progress of science and technology brings human beings a variety of digital electronic devices that make the living of people easy and convenient, such as digital cameras, digital camcorders, digital music players, personal digital assistants (PDAs), mobile phones, and notebook computers. Early products of electronic devices were of simple functions and they often had no function for network connection. However, at the present time, networks are prevailing and almost all the electronic devices named above are provided with network connecting functions to allow for instantaneous sharing of information and make the use thereof more convenient.

In light of this, a state-of-the-art electronic product is provided with both a micro USB and a micro-sized insertion receptacle formed in sides thereof for respective connection with a micro USB male connector and a micro card. However, providing the two types of connection ports in the same electronic product would make it impossible to reduce the overall size of the product. In view of the current trend of making electronic products small and compact in size, further improvement is desired.

### SUMMARY OF THE INVENTION

The primary object of the present invention is that an insulation body comprises a micro card receiving port and a micro USB connection port formed thereon to respectively receive a micro card and a micro USB male connector to insert therein. Through a collaborative operation of a card ejection bar and a card ejector, the micro card received in the micro card receiving port can be ejected out. With such an arrangement, the drawbacks of the conventional connector that cannot include a micro-sized and a micro USB to co-exist thereon can be overcome.

The present invention provides a multiple-in-one interface connector, which comprises an insulation body, a shielding casing, a micro transmission conductor assembly, a micro USB transmission conductor assembly, a card ejection bar, and a card ejector. The insulation body receives the micro transmission conductor assembly and the micro USB transmission conductor assembly to be arranged thereon and comprises a micro card receiving port formed on a surface thereof and a micro USB connection port formed at one side thereof. The shielding casing is arranged outside and encloses the insulation body. The card ejection bar is movably arranged at one side wall of the insulation body. The card ejector is rotatably mounted to the insulation body and is operatively coupled to the card ejection bar to be slidable on the micro card receiving port.

With such an arrangement, the purpose of a micro USB connection port and a micro card receiving port co-existing in a connector can be achieved. To carry out insertion of a micro USB male connector and a micro card, they are respectively inserted into and connected to the micro USB connection port and the micro card receiving port to achieve an advantage of simultaneous use thereof. To carry out ejection of the micro card, the card ejection bar is pushed to move the card ejector so as to have the micro card ejected out of the micro card receiving port to be subsequently removed. With the above described structure and operation, the advantage of micro-sized and micro USB connectors co-existing can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an embodiment of the present invention.

FIG. 2 is a top plan view of the embodiment of the present invention.

FIG. 3 is a front view of the embodiment of the present invention.

FIG. 4 is a side elevational view of the embodiment of the present invention.

FIG. 5 is a cross-sectional plan view of the embodiment of the present invention.

FIG. 6 is a perspective view showing the embodiment of the present invention with components removed to illustrate inside details.

FIG. 7 is a perspective view illustrating connection of the embodiment of the present invention with a micro USB male connector.

FIG. 8 is a perspective view illustrating connection of the embodiment of the present invention with a micro card.

FIG. 9 is a perspective view illustrating a first stage of ejection of the micro card from the embodiment of the present invention.

FIG. 10 is a perspective view illustrating a second stage of the ejection of the micro card from the embodiment of the present invention.

FIG. 11 is a perspective view showing another embodiment of the present invention.

FIG. 12 is a top plan view of said another embodiment of the present invention.

FIG. 13 is a front view of said another embodiment of the present invention.

FIG. 14 is a side elevational view of said another embodiment of the present invention.

FIG. 15 is a cross-sectional plan view of said another embodiment of the present invention.

FIG. 16 is a perspective view showing said another embodiment of the present invention with components removed to illustrate inside details.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

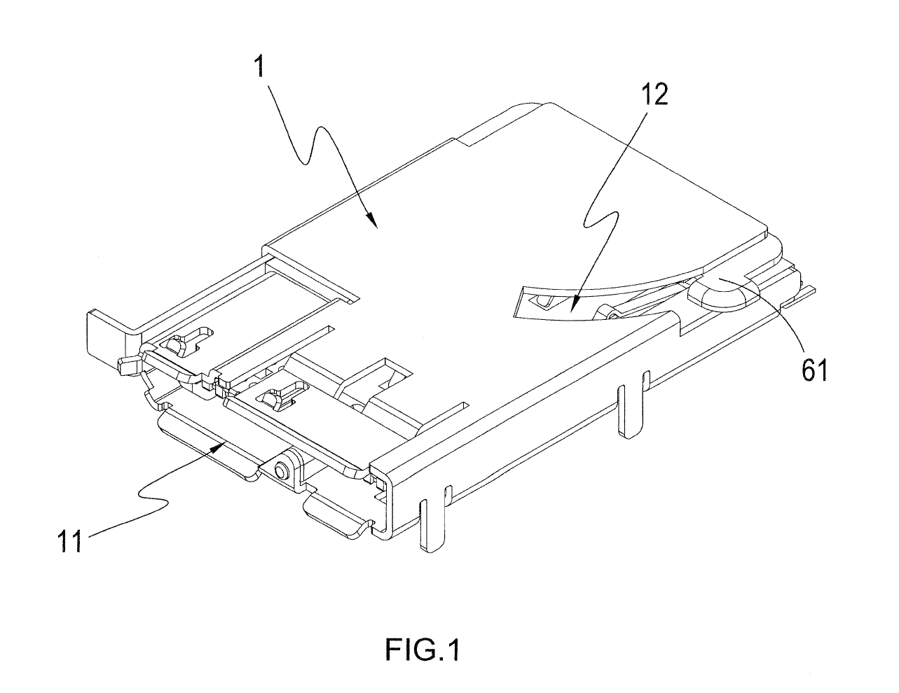

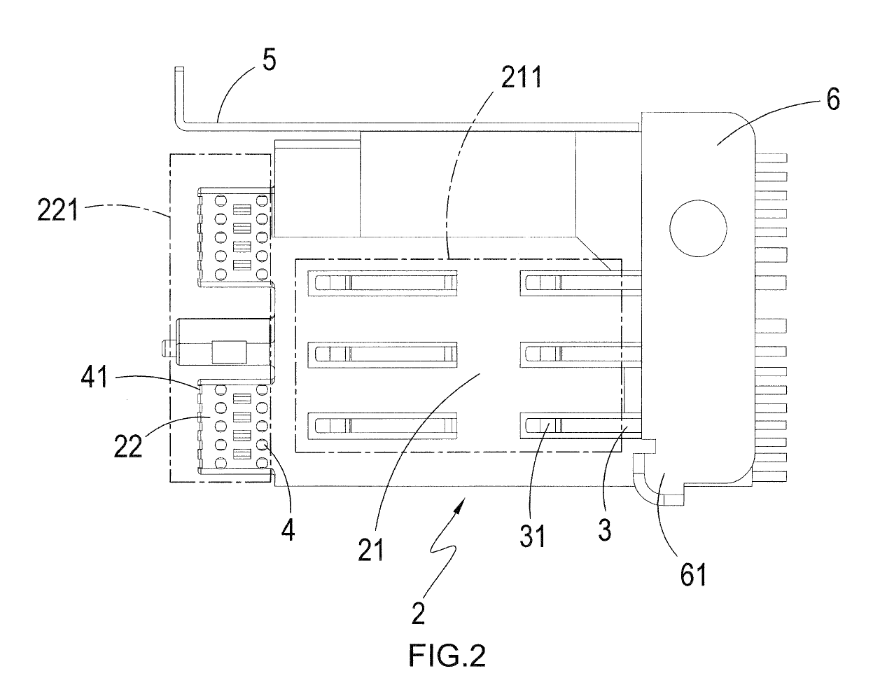

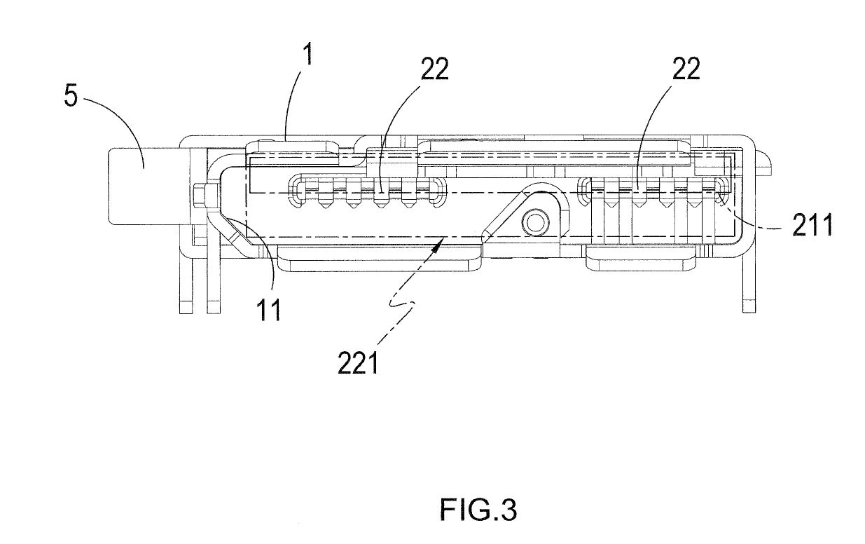

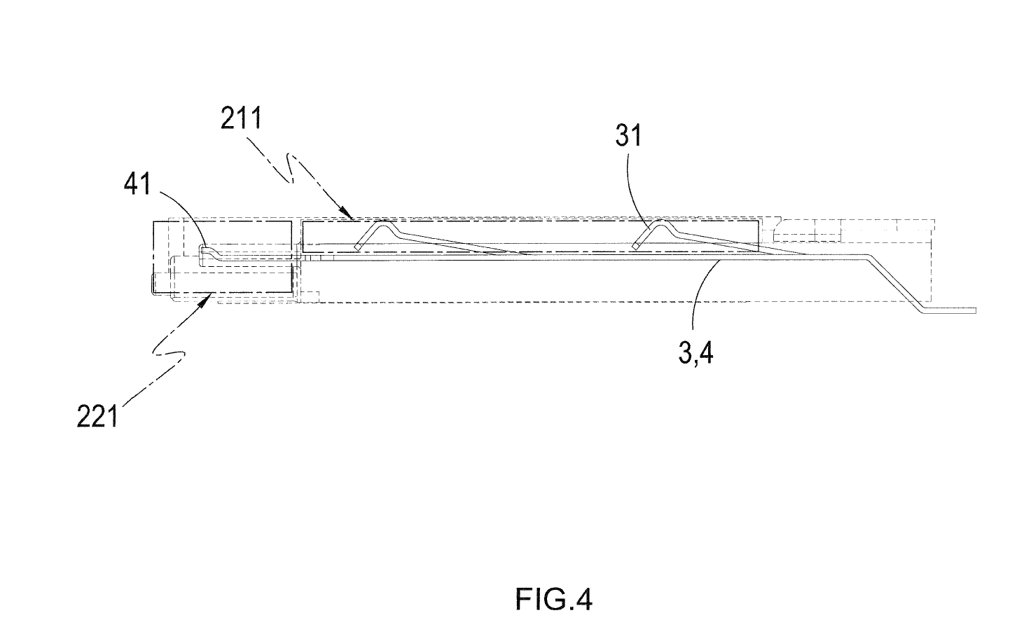

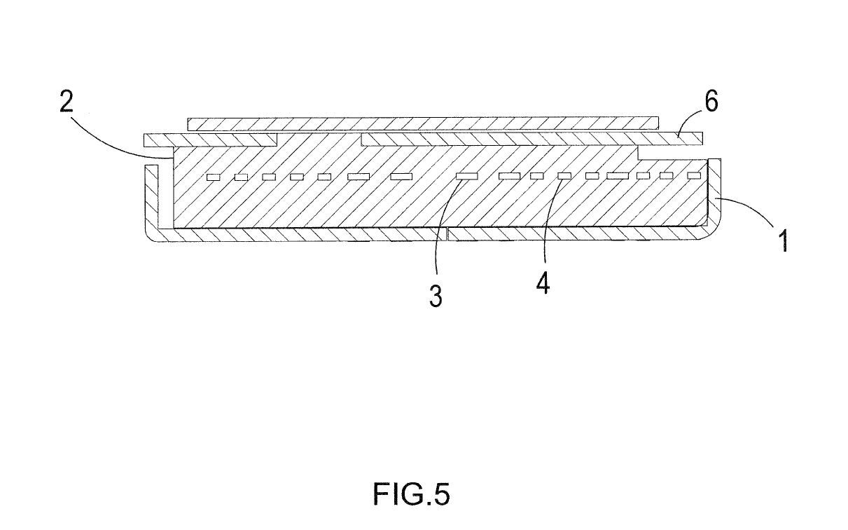

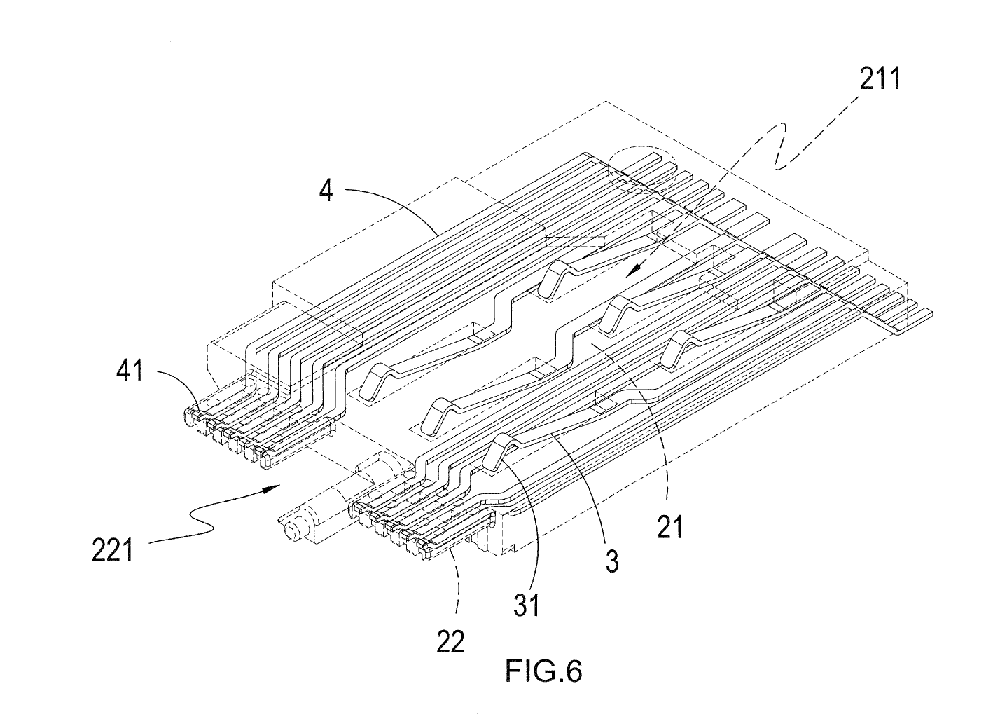

Referring to FIGS. 1-6, which are respectively a perspective view, a top plan view, a front view, a side elevational view, and a cross-sectional view of an embodiment of the present invention and a perspective view illustrating inside details of the embodiment of the present invention, these drawings clearly show that the present invention comprises:

a shielding casing 1, the shielding casing 1 defining an opening 11 and comprising a guide slot 12 formed in a side thereof;

an insulation body 2 coupled to the shielding casing 1 and received in the opening 11, the insulation body 2 defining a micro card receiving zone 211 in a surface thereof, the insulation body 2 defining a micro USB connection zone 221 under the micro card receiving zone 211, the insulation body 2 comprising a micro card receiving port 21 formed in the micro card receiving zone 211, the insulation body 2 comprising a micro USB connection port 22 formed in the micro USB connection zone 221, the micro card receiving zone 211 being located above the micro USB connection zone 221;

a micro transmission conductor assembly 3 arranged on the insulation body 2, the micro transmission conductor assembly 3 defining a micro transmission conductor contact section 31 at an end thereof, the micro transmission conductor contact section 31 being arranged on the micro card receiving port 21;

a micro USB transmission conductor assembly 4 arranged on the insulation body 2, the micro USB transmission conductor assembly 4 defining a micro USB transmission conductor contact section 41 at an end thereof, the micro USB transmission conductor contact section 41 being arranged on the micro USB connection port 22, the micro USB transmission conductor contact section 41 being located in front of the micro transmission conductor contact section 31;

a card ejection bar 5 received in the shielding casing 1 and movably arranged at one side of the insulation body 2; and

a card ejector 6 rotatably mounted to the insulation body 2 and operatively coupled to the card ejection bar 5, the card ejector 6 having an end on which a guide section 61 that is slidably received in the guide slot 12 is formed, the card ejector 6 being slidable on the micro card receiving port 21.

The micro transmission conductor assembly 3 and the micro USB transmission conductor assembly 4 that are described above are arranged on the insulation body to be parallel to each other.

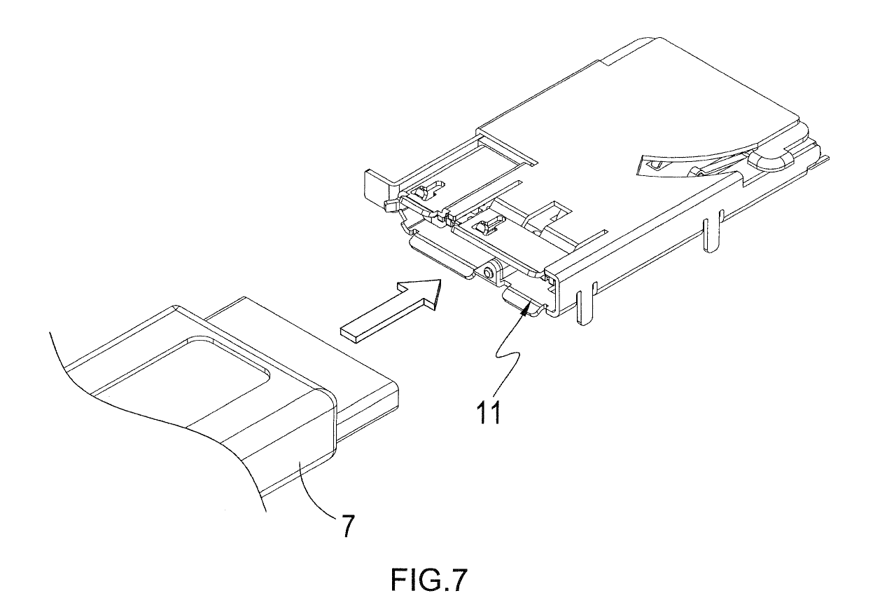

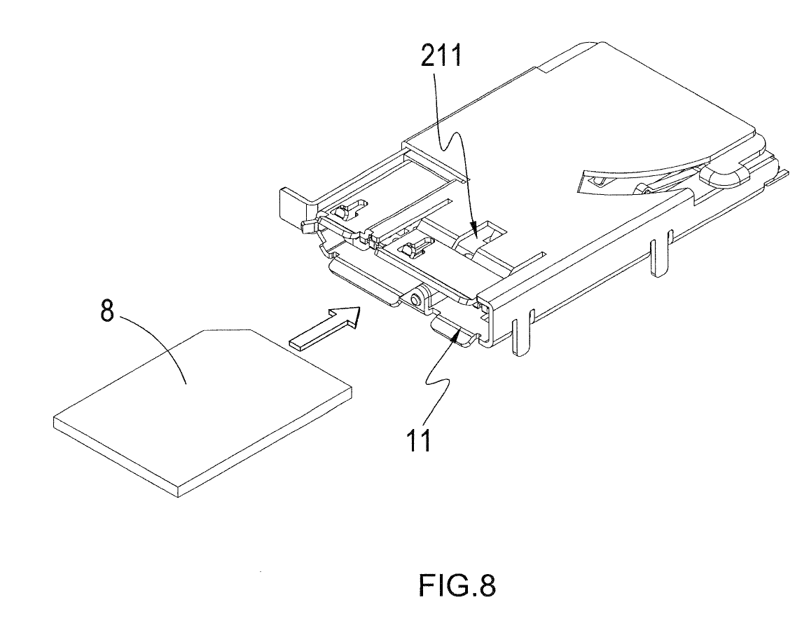

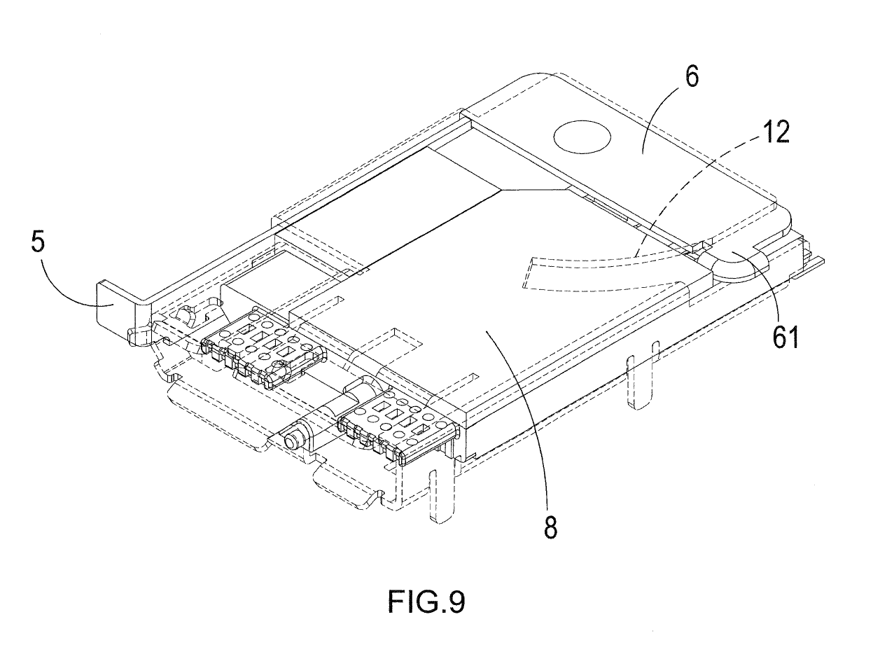

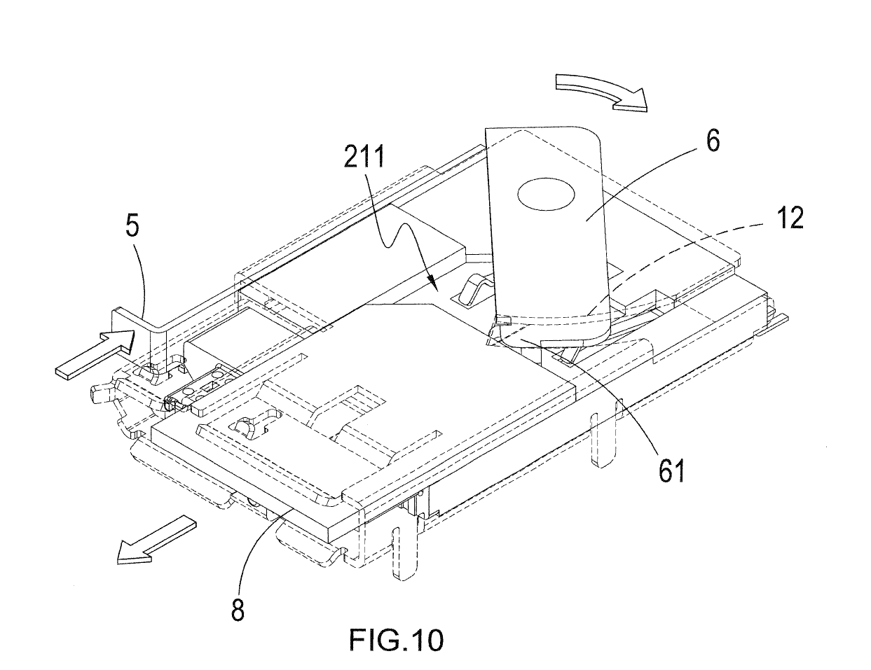

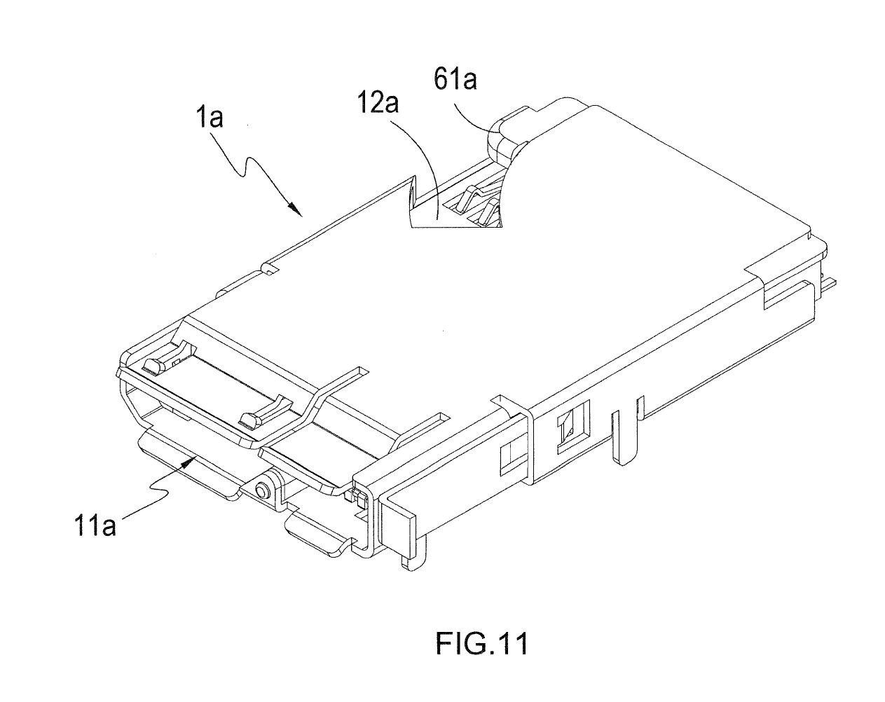

Referring to FIGS. 7-10, which are respectively a perspective view illustrating connection of the embodiment of the present invention with a micro USB male connector, a perspective view illustrating connection of the embodiment of the present invention with a micro card, a perspective view illustrating a first stage of ejection of the micro card from the embodiment of the present invention, and a perspective view illustrating a second stage of the ejection of the micro card from the embodiment of the present invention, the multiple-in-one interface connector according to the present invention can receive and couple to a micro USB male connector 7 and a micro card 8 individually or simultaneously. Referring to FIG. 8, a status of use where a micro USB male connector 7 is inserted is illustrated, wherein the micro USB male connector 7 is insertable through the opening 11 to achieve a connection and conducting condition. Referring to FIG. 9, a status of use where a micro card 8 is inserted is illustrated, wherein the micro card 8 is insertable through the opening 11 to have the micro card 8 received in the micro card receiving zone 211 and thus achieving a connection and conducting condition for operation. Referring to FIGS. 10 and 11, an operation of ejecting the micro card 8 from the micro card receiving zone 211 is illustrated, wherein when a card ejection bar 5 is pushed inward, the card ejection bar 5 drives a card ejector 6 to move so as to cause the card ejector 6 take a rotation about a fixed point to make the guide section 61 moving along the guide slot 12 so that the rotation of the card ejector 6 is made smooth. During the process of the operation, the card ejector 6 gradually ejects the micro card 8 out of the micro card receiving zone 211, whereby the micro card 8, when ejected out to a sufficient extent, can be removed by a user's hand. Oppositely, when a micro card 8 is inserted into the micro card receiving zone 211, the micro card 8 may drive the card ejector 6 to move so as to have the card ejection bar 5 return to a home position. Through the above described structure and explanation of operation, the superiority of the present invention is clearly demonstrated, wherein the micro card 8 and the micro USB male connector 7 can be simultaneously coupled to the connector of the present invention to achieve an advantage that a micro-sized and a micro USB co-exist.

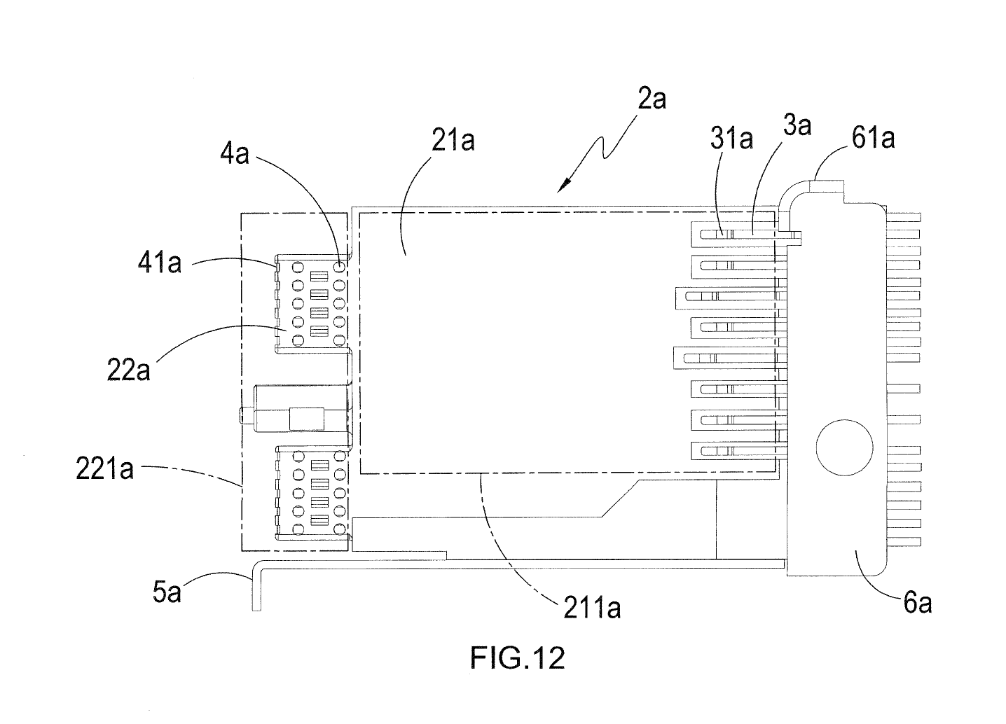

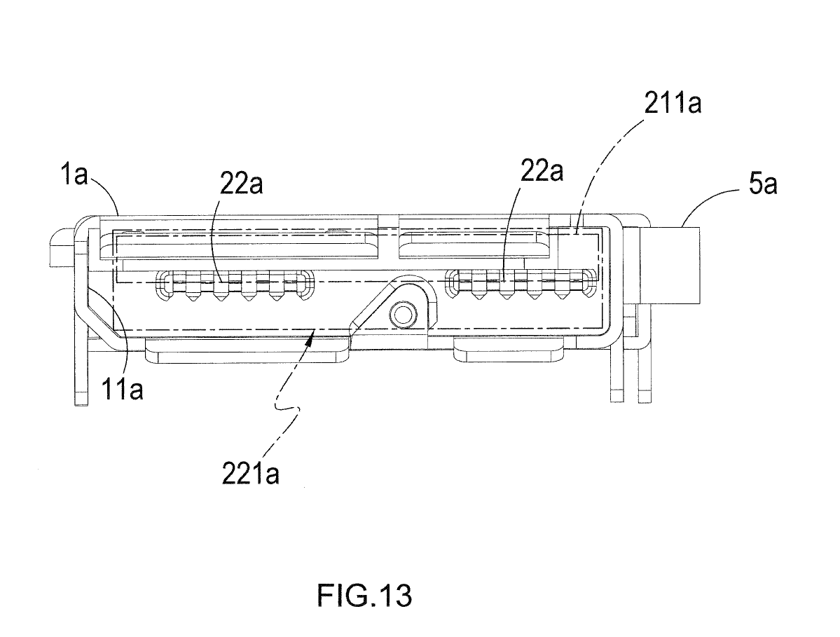

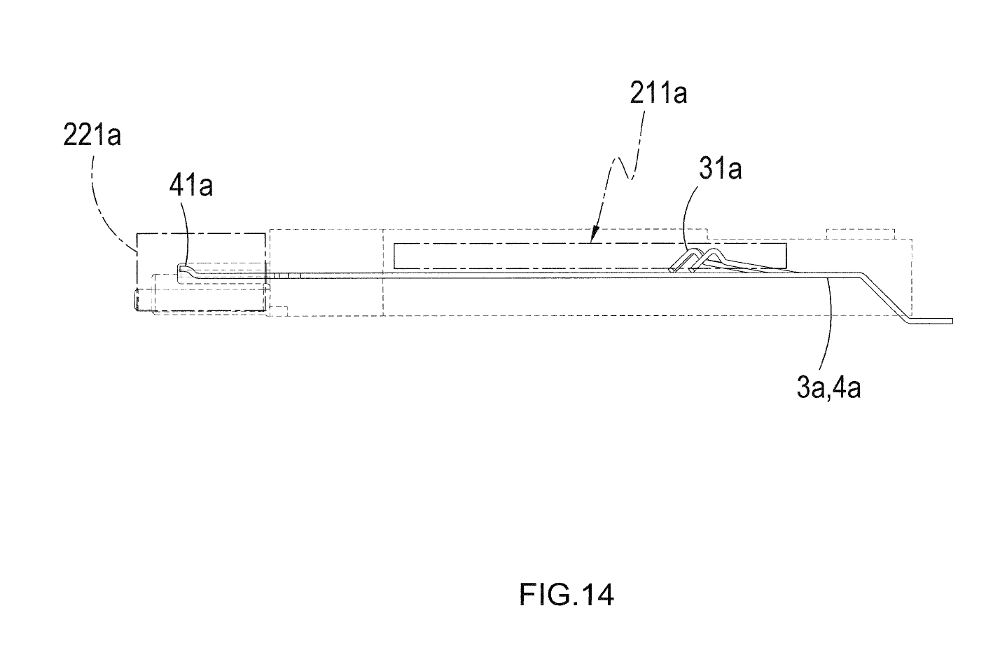

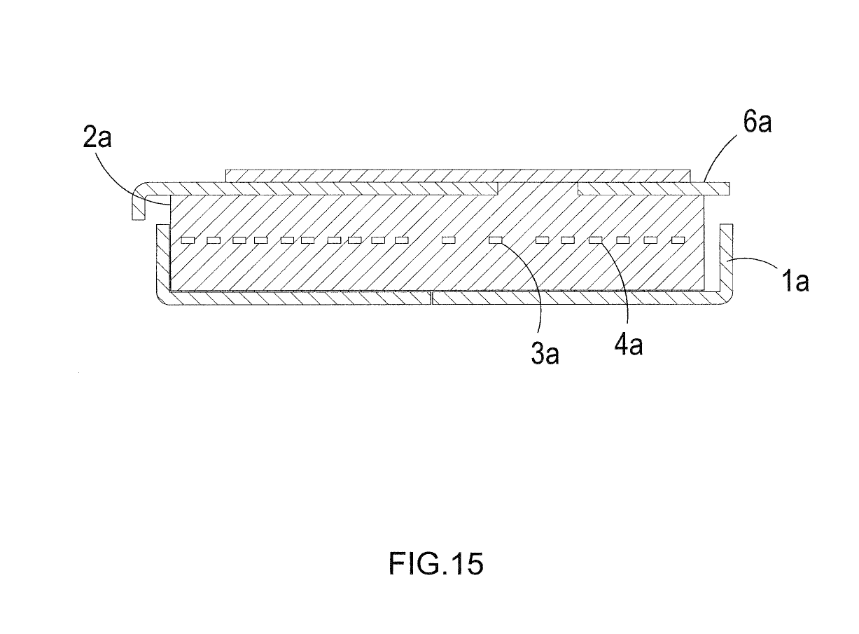

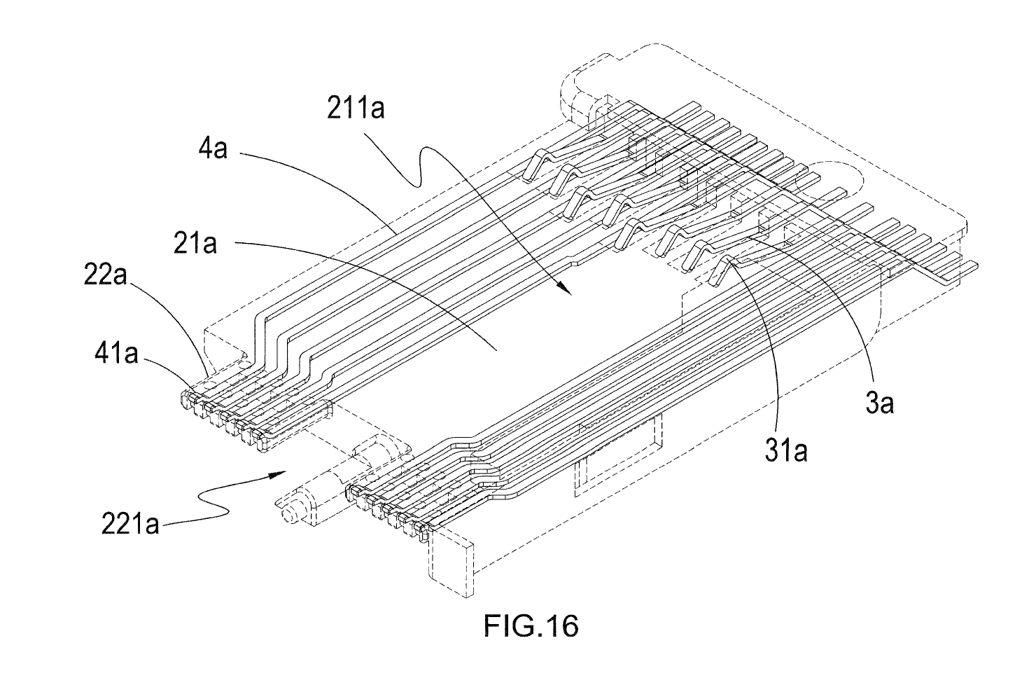

Referring to FIGS. 11-16, which are respectively a perspective view, a top plan view, a front view, a side elevational view, and a cross-sectional view of another embodiment of the present invention and a perspective view illustrating inside details of the embodiment of the present invention, these drawings clearly show that the present invention comprises:

a shielding casing 1a, the shielding casing 1 defining an opening 11a and comprising a guide slot 12a formed in a side thereof;

an insulation body 2a coupled to the shielding casing 1a and received in the opening 11a, the insulation body 2a defining a micro SD card receiving zone 211a in a surface thereof, the insulation body 2a defining a micro USB connection zone 221a under the micro SD card receiving zone 211a, the insulation body 2a comprising a micro SD card receiving port 21a formed in the micro SD card receiving zone 211a, the insulation body 2a comprising a micro USB connection port 22a formed in the micro USB connection zone 221a, the micro SD card receiving zone 211a being located above the micro USB connection zone 221a,

a micro SD transmission conductor assembly 3a arranged on the insulation body 2a, the micro SD transmission conductor assembly 3a defining a micro SD transmission conductor contact section 31a at an end thereof, the micro SD transmission conductor contact section 31a being arranged on the micro SD card receiving port 21a;

a micro USB transmission conductor assembly 4a arranged on the insulation body 2a, the micro USB transmission conductor assembly 4a defining a micro USB transmission conductor contact section 41a at an end thereof, the micro USB transmission conductor contact section 41a being arranged on the micro USB connection port 22a, the micro USB transmission conductor contact section 41a being located in front of the micro SD transmission conductor contact section 31a;

a card ejection bar 5a received in the shielding casing 1a and movably arranged at one side of the insulation body 2a; and

an card ejector 6a rotatably mounted to the insulation body 2a and operatively coupled to the card ejection bar 5a, the card ejector 6a having an end on which a guide section 61a that is slidably received in the guide slot 12a is formed, the card ejector 6a being slidable above the micro SD card receiving port 21a;

The micro SD transmission conductor assembly 3a and the micro USB transmission conductor assembly 4a that are described above are arranged on the insulation body to be parallel to each other.

In the instant embodiment, the structure is substantially similar to that of the previously embodiment and the difference is that the configuration of the instant embodiment is a configuration provided for receiving and coupling with a micro USB male connector and a micro SD card, the remaining structure being identical, wherein the micro SD card receiving zone 211a is located at the left side of the insulation body 2a and the operation thereof is similar to what described above so that repeated description will be omitted herein.

The technical features that the multiple-in-one interface connector of the present invention overcomes the drawbacks of the prior art are as follows:

A micro card receiving port 21 and a micro USB connection port 22 are both combined in a single insulation body 2 to achieve an advantage that a micro-sized and a micro USB connectors co-exist thereby achieving the purposes of miniaturizations and saving space.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multiple-in-one interface connector, comprising:
an insulation body, the insulation body defining a micro card receiving zone in a surface thereof, the insulation body defining a micro USB connection zone under the micro card receiving zone, the insulation body comprising a micro card receiving port formed in the micro card receiving zone, the insulation body comprising a micro USB connection port formed in the micro USB connection zone.

2. The multiple-in-one interface connector according to claim 1 further comprising a shielding casing, the shielding casing defining an opening, the insulation body being coupled to the shielding casing and received in the opening, the insulation body defining the micro card receiving zone in the surface thereof and the insulation body defining the micro USB connection zone under the micro card receiving zone so that the micro USB connection zone partly overlaps the micro card receiving zone and the micro USB connection zone and the micro card receiving zone are both located in the opening, the insulation body comprising the micro card receiving port formed in the micro card receiving zone, the insulation body comprising the micro USB connection port formed in the micro USB connection zone.

3. The multiple-in-one interface connector according to claim 1, wherein the insulation body defines the micro card receiving zone at one side thereof, the insulation body defining the micro USB connection zone at a front end of the micro card receiving zone, the insulation body comprising the micro card receiving port formed under the micro card receiving zone, the insulation body comprising the micro USB connection port formed in the micro USB connection zone.

4. The multiple-in-one interface connector according to claim 1, wherein the insulation body comprises a micro transmission conductor assembly arranged thereon and a micro USB transmission conductor assembly arranged on the insulation body, the micro USB transmission conductor assembly and the micro transmission conductor assembly being arranged on the insulation body to be parallel to each other.

5. The multiple-in-one interface connector according to claim 4 further comprising a shielding casing, the shielding casing defining an opening, the shielding casing receiving therein the insulation body, the micro USB transmission conductor assembly and the micro transmission conductor assembly being arranged on the insulation body to be parallel to each other, the micro USB transmission conductor assembly and the micro transmission conductor assembly being located in the opening.

6. The multiple-in-one interface connector according to claim 4, wherein the insulation body carries the micro transmission conductor assembly and the micro USB transmission conductor assembly, the micro USB transmission conductor assembly and the micro transmission conductor assembly being arranged on the insulation body in an overlapped manner.

7. A multiple-in-one interface connector, comprising:
a insulation body, the insulation body comprising a micro transmission conductor assembly and a micro USB transmission conductor assembly arranged thereon, the micro transmission conductor assembly defining a micro transmission conductor contact section at an end thereof, the micro USB transmission conductor assembly defining a micro USB transmission conductor contact section at an end thereof, the micro transmission conductor contact section being arranged above the micro USB transmission conductor contact section;
a micro card receiving port formed on a surface of the insulation body for receiving the micro transmission conductor contact section arranged therein; and
a micro USB connection port formed at one side of the insulation body for receiving the micro USB transmission conductor contact section arranged therein.

8. The multiple-in-one interface connector according to claim 7 further comprising a shielding casing, the shielding casing defining an opening, the insulation body being coupled to the shielding casing and received in the opening, the micro transmission conductor contact section being arranged above the micro USB transmission conductor contact section, the micro card receiving port being located in the opening, the micro USB connection port being located in the opening.

9. The multiple-in-one interface connector according to claim 7, wherein the micro transmission conductor contact section is located behind the micro USB transmission conductor contact section.

10. A multiple-in-one interface connector, comprising:
a shielding casing comprising a guide slot formed in one side thereof;
a insulation body received in the shielding casing, the insulation body comprising a micro card receiving port formed in one surface thereof, the insulation body comprising a micro USB connection port formed under the micro card receiving port;
a card ejection bar received in the shielding casing and movably arranged at one side of the insulation body; and
a card ejector rotatably mounted to the insulation body and operatively coupled to the card ejection bar, the card ejector having an end on which a guide section that is slidably received in the guide slot is formed, the card ejector being slidable on the micro card receiving port.
